(19) United States
(12) Patent Application Publication
(10) Pub. No.: US 2019/0362138 A1
(43) Pub. Date: Nov. 28, 2019

(54) System for Adaptive Teaching Using Biometrics

(71) Applicants: Gary Shkedy, San Diego, CA (US); Dalia Shkedy, San Diego, CA (US)

(72) Inventors: Gary Shkedy, San Diego, CA (US); Dalia Shkedy, San Diego, CA (US)

(21) Appl. No.: 15/988,114

(22) Filed: May 24, 2018

(51) Int. Cl. G06K 9/00; G09B 7/02; G09B 5/02

(52) U.S. Cl. CPC G06K 9/00302; G09B 5/02; G09B 7/02

(57) ABSTRACT

A system for adaptive teaching using biometrics to determine lessons to present to a student comprising: at least one server; at least one network; a client computer; and a biometric device operably connected to the student and a client computer. The server comprises a collection of modules and data for creating, managing, and controlling functions for: selecting a lesson to be taught from a school curriculum that is broken down into actionable tasks; presenting the selected lesson to the student; receiving a response, from the student, to the presented lesson; capturing the student's biometric data; evaluating the student response to determine if the lesson was completed correctly; determining the student's emotional state from the student's biometric data; and optimizing the parameters for selection of the next lesson to be presented to the student using the combined output of the response evaluation module and the output of the biometric evaluation module.

### FIELD OF THE INVENTION

The present invention relates generally to the field of computer aided teaching, and more specifically to a system for adaptive teaching using biometrics to determine lessons to present to a student.

### BACKGROUND

Teaching students requires the student to pay attention to the presented task and then perform the required action. For example we can present the student with a picture of an apple and the ask them to identify the picture. If the student does not engage with the computer, then the student will never learn without the teacher intervening.

Over the years, there have numerous solutions to this problem. Some companies have created education computer games in order to engage the student. These systems use the “excitement” of games to engage the student. Others use reward systems in order to encourage the student to engage. These reward systems could be tokens that are earned and later exchanged for a desired object etc.

For example, Sony Corporation, in patent US20110260830A1, discloses a handheld device that measures biometric data and changes the parameters of a game based on the readings. For example, they cite making a rifle less accurate when the user is stressed or increasing the area of the zoom when the user is stressed. Those skilled in the art will know that these methods only teach how to increase the difficulty of a task or present biofeedback to the user and not how to modify a task to increase learning. In fact the Sony device would be one input to the current system.

Similarly, in patents U.S. Ser. No. 14/536,599 and U.S. Pat. No. 9,700,802B2 Dugan teaches a method that motivates an exerciser to continue exercising or exercise harder based on biometric data. Dugan teaches how to use the biometric data to recommend a future exercise regimen.

When a student has a lot of skill and the challenge is easy, the student will be bored and hence will not engage with the task presented and thus not learn. Similarly if the student does not have a lot of skill and the challenge is too difficult, the student will become anxious and will disengage with the same outcome. The result is the same, the student does not learn. As the student practices and improves their skill, and the challenges are modified, the student will cycle between anxiousness and boredom. To make matters worse, if the student is tired or sick they are less likely to engage and therefore less likely to learn.

Every student responds differently to different stimuli. For example, in general, most boys are excited to count images of cars or perform addition with images of cars. On the other hand, most girls will be excited to describe the color of different items of clothing.

The problem with the existing solutions is that they have no indication of the emotional state of the student when presenting a task to be learned and thus have a higher likelihood of failure. The existing solutions have no idea if the presented stimuli excite or bore the student. They do not take into account that the student may be tired and therefore unable to learn new material. The existing solutions cannot determine if a student is in pain resulting from a headache and therefore is unable to learn.

Therefore, there is a need for a system for adaptive teaching using biometrics to determine lessons to present to a student.

### BRIEF DESCRIPTION OF THE DRAWINGS

These and other features, aspects and advantages of the present invention will become better understood with regard to the following description, appended claims, and accompanying figures where:

FIG. 1 is a diagram of a computer implemented system for adaptive teaching using biometrics to determine lessons to present to a student; according to one embodiment;

FIG. 2 is a detailed schematic view of the server of FIG. 1;

FIG. 3 is a flowchart diagram of a method for the system of FIG. 1; and

FIG. 4 is a schematic diagram of a portion of the program 240 of FIG. 2 that comprises modules of instructions executable on a processor for performing the processes shown and described.

### SUMMARY

The present invention overcomes the limitations of the prior are by providing a system for adaptive teaching using biometrics to determine lessons to present to a student. The system comprises at least one server; at least one network operably connected to the at least one server; one or more than one client computers operably connect to the at least one network; and one or more than one biometric device operably connected to the student and the one or more than one client computer. The server comprises a collection of machine readable instruction modules and data, executable on a processor for creating, managing, and controlling functions for: a selection module for selecting a lesson to be taught, where the lesson to be taught is part of a school curriculum that is broken down into actionable tasks; a display module for presenting the selected lesson to the student; a student response module for receiving a response, from the student, to the presented lesson; a biometric response module for capturing the student's biometric data; a response evaluation module for evaluating the student response to determine if the lesson was completed correctly; a biometric evaluation module to determine the student's emotional state from the student's biometric data; and a diagnostic module to optimize the parameters for selection of the next lesson to be presented to the student using the combined output of the response evaluation module and the output of the biometric evaluation module. The lessons to be taught can be a sequence of lessons and tasks.

There is also provided a method for adaptive teaching using biometrics to determine lessons to present to a student. The method comprises the steps of, first operably connecting one or more than one biometric device to a student. Then, selecting a lesson to be taught, where the lesson to be taught is part of a school curriculum that is broken down into actionable tasks. Next, presenting the selected lesson to the student. Then, receiving a response from the student to the presented lesson. Next, capturing the student's biometric data from the one or more than one operably connected biometric device. Then, evaluating the student response to determine if the lesson was completed correctly. Next, determining the student's emotional state from the student's biometric data. Then, optimizing the parameters for selection of the next lesson to be presented to the student using the combined output of the response evaluation module and the output of the biometric evaluation module. Finally, repeating the steps until all lessons are completed.

Additionally, there is provided a computer-implemented method for adaptive teaching using biometrics to determine lessons to present to a student. The computer-implemented method comprises the steps of first operably connecting one or more than one biometric device to a student and a computer. Then, selecting a lesson to be taught from a server, where the lesson to be taught is part of a school curriculum that is broken down into actionable tasks. Next, presenting the selected lesson to the student. Then, receiving a response from the student to the presented lesson. Next, capturing the student's biometric data from the one or more than one operably connected biometric device. Then, evaluating the student response to determine if the lesson was completed correctly. Next, determining the student's emotional state from the student's biometric data. Then, optimizing the parameters for selection of the next lesson to be presented to the student using the combined output of the response evaluation module and the output of the biometric evaluation module. Finally, repeating each step until all lessons are completed.

In one aspect of the invention, there is provided a method that includes the following steps: (i) selecting a lesson to display, (ii) displaying the lesson and (iii) establishing the student's current biometric readings and capturing the student's response and (iv) combining the student's response with their biometric state to select the next lesson. All of these steps are performed by computer software running on computer hardware.

it is one object of the present invention to combine the student's biometric information with the student's performance data to determine the sequence of lessons to be presented to the student.

It is another object of the invention to use biometric information to establish the emotional state of the student and adjust the presented lessons accordingly.

It is another object of the invention to combine current biometric information with the complete history of their performance and biometric data to determine the lesson to be presented to the student.

It is another object of the invention to combine biometric information of all students with the complete history of the performance and biometric data of all students to determine the lesson to be presented to the particular student.

It is another object of the invention to combine data from external stimuli with the biometric information and the performance data of the student to determine the lesson to be presented.

These and other objects of the invention will be apparent to those skilled in the art from the following detailed description of the invention, the accompanying drawings and the claims.

### DETAILED DESCRIPTION OF THE INVENTION

The present invention overcomes the limitations of the prior art by providing a system for adaptive teaching using biometrics to determine lessons to present to a student. The present invention facilitates numerous student needs. For example:
1) Teaching special needs students who struggle to attend to a task and need motivating lessons in order to be engaged.
2) Teaching students a dynamic curriculum that evolves based on their emotional state.
3) Teaching a student how to play the piano while changing the type of music they use based on their level of excitement as measured by the biometric systems.
4) Playing background music in a class and using performance and biometric data to modify the music in order to maximize the learning.
5) Using machine learning to present the next lesson that uses performance and biometric data as inputs.

All of these student needs, and more, can be met and accomplished using the present invention.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Systems, methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods and computer programs according to various embodiments disclosed. In this regard, each block in the flowchart or block diagrams can represent a module, segment, or portion of code, that can comprise one or more executable instructions for implementing the specified logical function(s). It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

Various embodiments provide a system for adaptive teaching using biometrics to determine lessons to present to a student. One embodiment of the present invention provides a computer implemented system for adaptive teaching using biometrics to determine lessons to present to a student. In another embodiment, there is provided a method for using the system. The system and method will now be disclosed in detail.

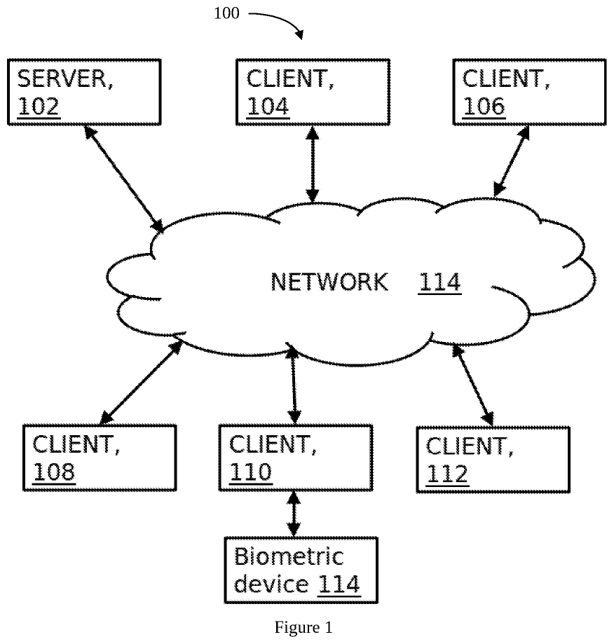

Referring now to FIG. 1, there is shown a diagram of a computer implemented system 100 for adaptive teaching using biometrics to determine lessons to present to a student; according to one embodiment. As can be seen, the system 100 comprises at least one server 102, one or more than one client computers 104, 106, 108, 110, 112, and a communications network 114.

The server 102 may be a laptop computer that comprises modules of instructions executable on a processor for performing the processes shown and described netbook computer, personal computer, tablet computer, netbook computer, personal computer, a desktop computer, a personal digital assistant, a smart phone, or any programmable electronic device capable of communicating with the client computers 104-112 via network 114. Server 102 is capable of communicating with the client computers 104-112 via network 114. Network 114 can be, for example, a local area network, a wide area network such as the Internet, or a combination of the two, and can include wired, wireless or fiber optic connections. In general, the network 114 can be any combination of connections and protocols that will support communications between the server 102 and the client computers 104-112.

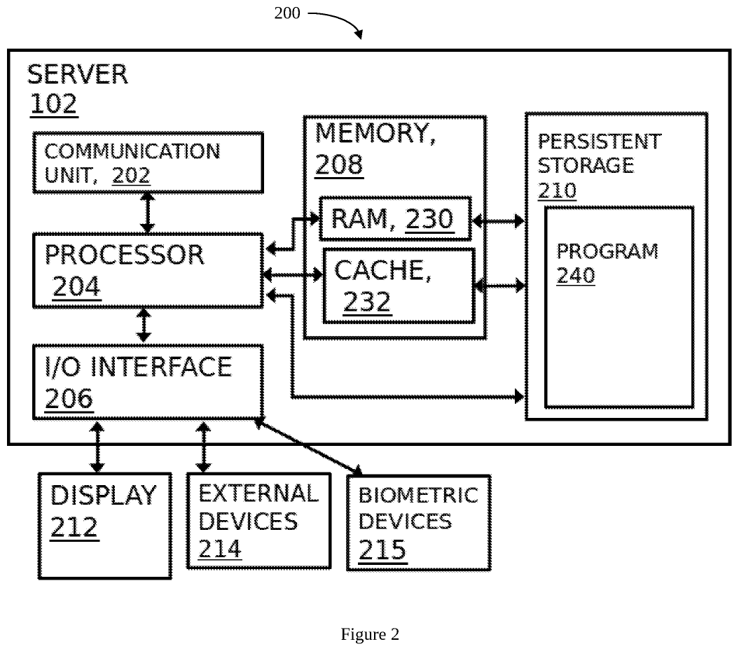

Referring now to FIG. 2, there is shown a detailed schematic view 200 of the server 102 of FIG. 1. The detailed schematic view 200 shows that the server 102 comprises a communication unit 202, a processor set 204, an input/output (i/o) unit 206, a memory device 208, a persistent storage device 210, a display device 212, an external device set 214, random access memory (RAM) 230, a cache memory device 232; and program 240.

The program 240 is a collection of machine readable instructions and data executable on a processor for creating, managing, and controlling functions that will be discussed in detail, below. Program 240 comprises various executable instruction useful for the system 100 and is stored in persistent storage 210 for access and/or execution by one or more computer processors 204. The program 240 can also comprise both machine readable and performable instructions and/or substantive data, where the substantive data is stored in a database. The program 240 may be stored and run locally or remotely. For example, program 240 may be stored and run on a tablet computer such as an iPad, rather than on a remote server.

Communications unit 202 provides communications with other data processing systems or devices external to the server 102, such as client sub-systems 104, 106, 108, 110, 112. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface(s) 206 allows for input and output of data with other devices that may be connected locally in data communication with server 102. For example, I/O interface 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards, Software and data used to practice embodiments of the present invention, for example, program 240, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor, a tablet computer or a smart phone display screen.

Biometric device 215 is one or more than one device physically or operably connected to a student to collect biometric data from the student. For example, a camera for facial recognition, a heart rate monitor, electro-muscular measurement, measurement of galvanic skin resistance or a blood pressure monitor. There are many biometric devices that can be used in the present invention, such as an Apple Watch, Fitbit or custom biometric devices. The biometric devices described are not intended to be limiting, but on exemplars of possible biometric devices.

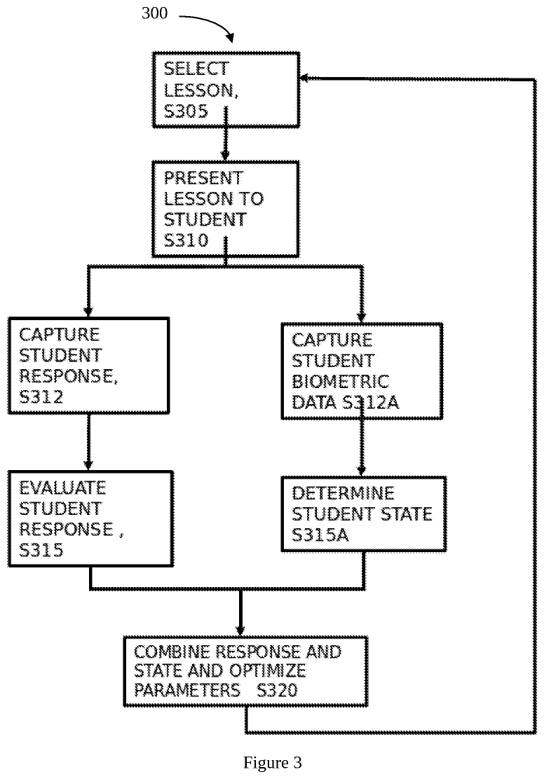

Referring now to FIG. 3, there is shown a flowchart diagram 300 of a method for the system 100. First, a lesson is selected S305 from a selection module that defines the lesson to be taught, where the lesson to be taught is part of a school curriculum that is broken down into actionable tasks. Alternatively, the lessons to be taught can be a sequence of lessons and tasks to repair an appliance or learn how to play a musical instrument. Next, the selected lesson is presented to the student S310. Then, the student response module 360 receives a response S312 to the lesson. Examples of a student response S312 could be the answer selected in a multiple choice question or the drawing the student produces. Concurrently, the students biometric response module 362 will capture the student's biometric data S312A. Examples of this would be their heart rate or facial expressions or both. Next, a response evaluation module 375 evaluates the student response S315 to determine if the lesson was completed correctly. Those skilled in the art will know that correct is not necessarily a binary right or wrong but incorporates the fuzziness of percent correct. Concurrently, a biometric evaluation module 370 will use the biometric data to determine the student's emotional state S315A. Then, a diagnostic module 380 combines the output of the response evaluation module 375 with the output of the biometric evaluation module 370 to optimize the parameters S320 for selection of the next lesson to be presented to the student.

For example, a user at one of the client computers 104-112 is taught the concept of color using an application with adaptive biometric teaching. First, a display keyboard module 365 receives a request through network 114 and chooses a lesson to work on. The system 100 sends data to the client computer 104-112 so that the user is presented with the selected lesson. As the student answers the questions for the lesson, the system 100 concurrently measures the biometric data. The system 100 also evaluates the combines response of the student and biometric data to determine the next lesson to present.

In another embodiment, the biometric data is used in conjunction with external stimuli and the performance data of the student. Examples of this could be background music or lighting that influence how a student is learning. a student who is terrified of spiders and so should not be shown pictures of spiders in the lessons. Alternatively, it could be a student who is extremely motivated by insects and so can be taught counting and addition using insects.

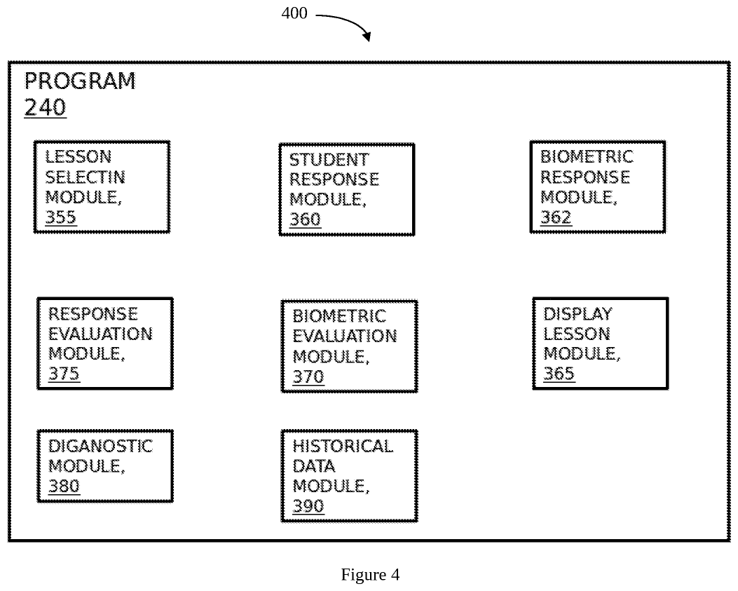

Referring now to FIG. 4, there is shown a schematic diagram of a portion of the program 240 that comprises modules of instructions executable on a processor for performing the processes shown and described. The program 240 comprises a lesson selection module 355, a student response module 360, a biometric response module 362, a response evaluation module 375, a biometric evaluation module 370, a display lesson module 365 and a diagnostic module 380.

The lesson selection module 355 provides a database of all lessons available and the questions within each of the lessons. The questions can be modified to fit the biometric data that is collected from the student.

The student response module 360, is configured to store the student's responses to the presented questions. Additionally, the student responses along with their associated biometric data and other indicia, such as, for example, the day, time, weather conditions, are also stored in the server 102.

The biometric response module 362 comprises instructions for detecting and storing the student's biometric data. Since various biometric devices can be used to help student learning, the biometric response module 362 comprises all the executable instructions to interface with each of the biometric devices and record the devices input.

The response evaluation module 375 comprises instructions for combining the information from the student response module 360 and the biometric response module 362 to determine the questions for each lesson to optimize the students learning and understanding.

The display lesson module 365 displays the required task on the users display. Examples of a required task could be a paragraph coupled with a multiple choice question, a mathematical equation coupled with a response area or a question with a response area where the student could draw or type an answer. Those skilled in the art will know that there are numerous methods for the presentation of a concept and numerous methods that can be used to obtain a response.

The diagnostic module 380 comprises instructions for determining the next question to present to the student by evaluating both the student's response and the biometric data collected. Additionally, the lesson presented to the student S310 can be constructed to use a timer to indicate that the student response is not forthcoming and therefore the diagnostic module 380 should just use biometric data. Alternatively, the change in biometric data could be so significant as to indicate that the student is unlikely to respond and therefore the diagnostic module 380 should just use biometric data. The diagnostic module 380 can take particular student issues into account, for example, a student who is terrified of spiders and so should not be shown pictures of spiders in the lessons. Alternatively, it could be a student who is extremely motivated by insects and so can be taught counting and addition using insects. The diagnostic module 380 could use the historical data module 390 in conjunction with the results of steps S315 and step S315A in the selection of the next question to present to the student.

The historical data module 390 is optionally available for use in the system 100. Each of the steps S320 can be constructed so that the diagnostic module 380 could use the historical data module 390 in conjunction with the results of steps S315 and step S315A from all client computers 104-112. Also, the complete performance and biometric history of all the students is used to determine the lesson for each student. Examples of this could be a class competition where the state of a student will be influenced by the “energy” in the classroom.

The diagnostic module 380 could use the historical data module 390 in conjunction with the results of steps S315 and step S315A to construct questions in step S320.

As will be understood by those with skill in the art with reference to this disclosure, the above examples provide only an illustration of one implementation and does not imply any limitations with regard to the invention where different embodiments may be implemented. Many modifications to the invention may be made, especially with respect to the current and anticipated future advances in cloud computing, distributed computing, and smaller computing devices, network communications and the like.

What has been described is a new and improved system for a system for adaptive teaching using biometrics to determine lessons to present to a student, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A system for adaptive teaching using biometrics to determine lessons to present to a student, the system comprising:
a) at least one server;
b) at least one network operably connected to the at least one server;
c) one or more than one client computers operably connect to the at least one network; and
d) one or more than one biometric device operably connected to the student and the one or more than one client computer.

2. The system of claim 1, where the server comprises a collection of machine readable instruction modules and data, executable on a processor for creating, managing, and controlling functions for:
a) a selection module for selecting a lesson to be taught, where the lesson to be taught is part of a school curriculum that is broken down into actionable tasks;
b) a display module for presenting the selected lesson to the student;
c) a student response module for receiving a response, from the student, to the presented lesson;
d) a biometric response module for capturing the student's biometric data;
e) a response evaluation module for evaluating the student response to determine if the lesson was completed correctly;
f) a biometric evaluation module to determine the student's emotional state from the student's biometric data; and
g) a diagnostic module to optimize the parameters for selection of the next lesson to be presented to the student using the combined output of the response evaluation module and the output of the biometric evaluation module.

3. The system of claim 2, where the lessons to be taught can be a sequence of lessons and tasks.

4. A method for adaptive teaching using biometrics to determine lessons to present to a student, the method comprising the steps of:
a) operably connecting one or more than one biometric device to a student;
b) selecting a lesson to be taught, where the lesson to be taught is part of a school curriculum that is broken down into actionable tasks;
c) presenting the selected lesson to the student;
d) receiving a response from the student to the presented lesson;
e) capturing the student's biometric data from the one or more than one operably connected biometric device;
r) evaluating the student response to determine if the lesson was completed correctly;
g) determining the student's emotional state from the student's biometric data;
h) optimizing the parameters for selection of the next lesson to be presented to the student using the combined output of the response evaluation module and the output of the biometric evaluation module; and
i) repeating steps b-h until all lessons are completed.

5. A computer-implemented method for adaptive teaching using biometrics to determine lessons to present to a student, the computer-implemented method comprising the steps of:
a) operably connecting one or more than one biometric device to a student and a computer;
b) selecting a lesson to be taught from a server, where the lesson to be taught is part of a school curriculum that is broken down into actionable tasks;
c) presenting the selected lesson to the student;
d) receiving a response from the student to the presented lesson;
e) capturing the student's biometric data from the one or more than one operably connected biometric device;
r) evaluating the student response to determine if the lesson was completed correctly;
g) determining the student's emotional state from the student's biometric data;
h) optimizing the parameters for selection of the next lesson to be presented to the student using the combined output of the response evaluation module and the output of the biometric evaluation module; and
i) repeating steps b-h until all lessons are completed.
